(19) United States
(12) Patent Application Publication
(10) Pub. No.: US 2024/0424433 A1
(43) Pub. Date: Dec. 26, 2024

(54) SYSTEMS AND METHODS FOR IN-LINE FILTERING OF DEBRIS IN SWIMMING POOLS AND SPAS

(71) Applicant: ZODIAC POOL SYSTEMS LLC, Carlsbad, CA (US)

(72) Inventors: Quintin Buse, Carlsbad, CA (US); Dustin Borg, Poway, CA (US)

(73) Assignee: ZODIAC POOL SYSTEMS LLC, Carlsbad, CA (US)

(21) Appl. No.: 18/746,024

(22) Filed: Jun. 17, 2024

Related U.S. Application Data
(60) Provisional application No. 63/521,966, filed on Jun. 20, 2023.

(51) Int. Cl. B01D 29/90; B01D 29/15; B01D 35/30; C02F 1/00; C02F 103/42; E04H 4/12

(52) U.S. Cl. CPC B01D 29/904; B01D 29/15; B01D 35/30; C02F 1/001; B01D 2201/282; B01D 2201/304; B01D 2201/4092; C02F 2103/42; C02F 2201/004; C02F 2209/40; E04H 4/1209

(57) ABSTRACT

Disclosed are filter systems and methods for swimming pools and spas for leaves and other larger debris. The disclosed filtering devices may be provided in-line with a pool cleaning or filtering system such that filtering devices pre-filter the larger debris before the pool cleaning or filtering system filters smaller debris. In some cases, the filtering devices provide an airtight seal that is easy for a user to open or close as desired. In some cases, the disclosed filtering devices include a filter between an inlet and an outlet that are parallel to and offset from a center axis of the filter. In some cases, the filtering devices are configured to generate horizontal cyclonic flow of water.

### REFERENCE TO RELATED APPLICATION

This application claims the benefit of U.S. Provisional Patent Application No. 63/521,966, filed on Jun. 20, 2023, and entitled SYSTEMS AND METHODS FOR IN-LINE FILTERING OF DEBRIS IN SWIMMING POOLS AND SPAS, the content of which is hereby incorporated by reference in its entirety.

### FIELD OF THE INVENTION

This invention relates to filter systems and methods for swimming pools and spas, and more particularly, although not exclusively, to filter systems for leaves and other debris.

### BACKGROUND OF THE INVENTION

A pool cleaning system will commonly filter various debris from a swimming pool or spa to control water quality of the swimming pool or spa. Some debris may be relatively large, such as leaves, twigs, pine straw, insects, and the like, and if such debris is drawn into the pool cleaning system, it may prematurely clog a pool filter of the pool cleaning system and/or otherwise interfere with operation of the pool cleaning system. One approach to minimize the impact of such larger debris has been to use a leaf or debris trap to pre-filter the larger debris before the water is directed to the main filtering equipment of the pool cleaning system, such as the debris trap illustrated in U.S. Pat. No. 5,269,913 to Atkins. These debris traps are commonly in-line with an inlet and an outlet at a top of the debris trap and a housing extending downwards and perpendicularly between the inlet and the outlet. The canister prevents direct fluid flow from the inlet to the outlet such that water and debris are directed downwards, with debris becoming trapped and unable to reach the outlet.

While such traditional debris traps filter larger debris, they are bulky and increase the profile of the debris trap relative to conduit and/or hosing that the debris trap is connected to (e.g., they are elongated in a direction generally perpendicular to a flow path defined by the inlet and/or outlet). Such bulky and increased profiles increase potential interference with other equipment and/or users within the swimming pool or spa.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, an in-line filtering device for a swimming pool or spa, includes an inlet, an outlet, and a filter between the inlet and the outlet. In some embodiments, the inlet and the outlet are parallel to and offset from a center axis of the filter.

According to various embodiments, an in-line filtering device includes a canister top defining an inlet, a canister body defining an outlet and with a center axis, and the inlet and the outlet are parallel to but offset from the center axis.

According to some embodiments, an in-line filtering device includes an inlet, and outlet, and a canister body. In various embodiments, the in-line filtering device may generate cyclonic flow within the canister body about an axis parallel to and offset from the inlet and the outlet.

According to certain embodiments, an in-line filtering device includes a canister top defining an inlet, a canister body defining an outlet, and a filter within the canister body. In some cases, the canister top further includes a locking knob for selectively sealing the canister top relative to the canister body.

According to some embodiments, an in-line filtering device includes a canister top defining an inlet, a canister body defining an outlet, and a filter within the canister body. In various embodiments, an axis of the filter is parallel to and offset from at least one of an axis of the inlet or an axis of the outlet.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 illustrates an in-line filtering device according to embodiments.

FIG. 2 is another view of the in-line filtering device of FIG. 1 according to embodiments.

FIG. 3 is another view of the in-line filtering device of FIG. 1 according to embodiments.

FIG. 4 is another view of the in-line filtering device of FIG. 1 according to embodiments.

FIG. 5 is another view of the in-line filtering device of FIG. 1 according to embodiments.

FIG. 6 illustrates a portion of the in-line filtering device of FIG. 1 according to embodiments.

FIG. 7 illustrates a portion of the in-line filtering device of FIG. 1 according to embodiments.

FIG. 8 is another view of the in-line filtering device of FIG. 1 according to embodiments.

FIG. 9 is another view of the in-line filtering device of FIG. 1 according to embodiments.

FIG. 10 illustrates a portion of the in-line filtering device of FIG. 1 according to embodiments.

FIG. 11 illustrates a portion of the in-line filtering device of FIG. 1 according to embodiments.

FIG. 12 illustrates a portion of the in-line filtering device of FIG. 1 according to embodiments.

FIG. 13 illustrates a portion of the in-line filtering device of FIG. 1 according to embodiments.

FIG. 14 illustrates a portion of the in-line filtering device of FIG. 1 according to embodiments.

FIG. 15 illustrates a portion of the in-line filtering device of FIG. 1 according to embodiments.

### DESCRIPTION OF THE INVENTION

Described herein are filtering devices for swimming pools or spas with improved filtering, particularly of larger debris such as but not limited to leaves, twigs, pine straw, insects, and the like. In some embodiments, the filtering devices described herein may be provided in-line with a pool cleaning or filtering system such that filtering devices pre-filter the larger debris before the pool cleaning or filtering system filters smaller debris. In certain embodiments, the filtering devices herein provide an airtight seal that is easy for a user to open or close as desired. The filtering devices described herein may minimize and/or prevent air from leaking into a suction line of a filtering system, which may lead to a filter pump losing its prime.

In some embodiments, the filtering devices described herein include an inlet and an outlet that are parallel to but offset from a center axis of the filtering device. In various embodiments, such offset alignment may allow for air to be purged out of the filtering device that would otherwise get trapped when the inlet and outlet are on-axis with the center axis. In certain embodiments, the filtering devices described herein may generate cyclonic flow within the filtering device along the center axis, which may push debris along the axis and minimize and/or prevent debris from getting clogged along the length of the filtering device while creating more room for debris on the inlet side of the filtering device. A flow gauge may be provided with the filtering devices described herein, and optionally, the flow gauge may be integrated into the filtering device. Compared to traditional approaches, in which the debris traps are elongated and have a maximum dimension in a direction perpendicular to a direction of flow at an inlet or an outlet, the debris traps described herein are elongated and have a maximum dimension in a direction generally parallel to the direction of flow at the inlet or outlet. Various other benefits and advantages may be realized with the systems, devices, and methods provided herein, and the aforementioned advantages should not be considered limiting.

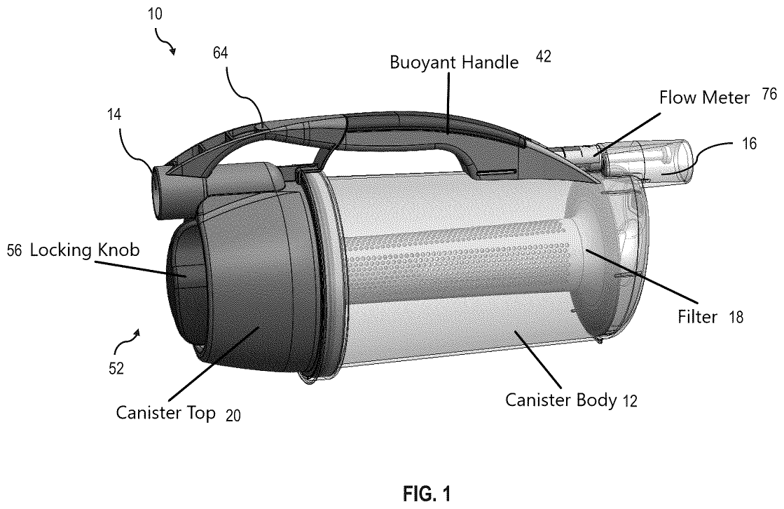

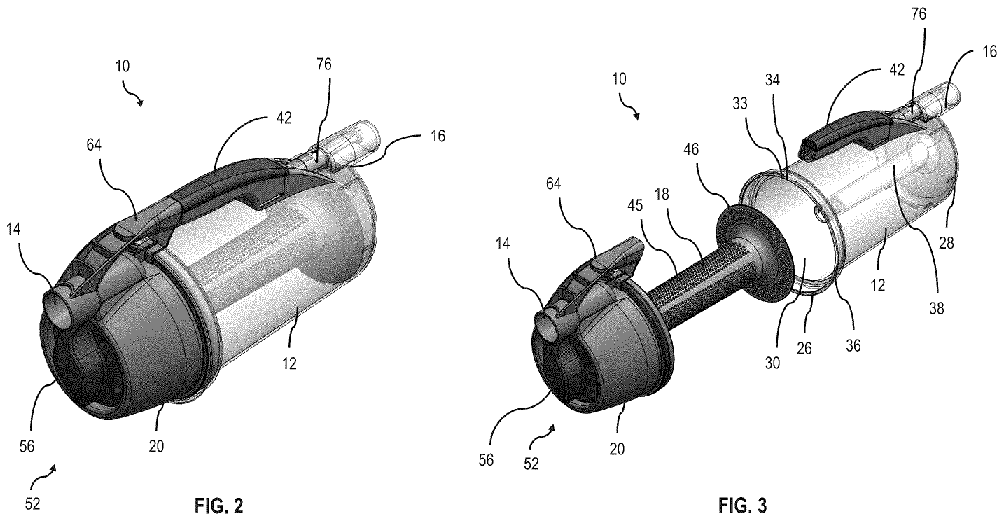

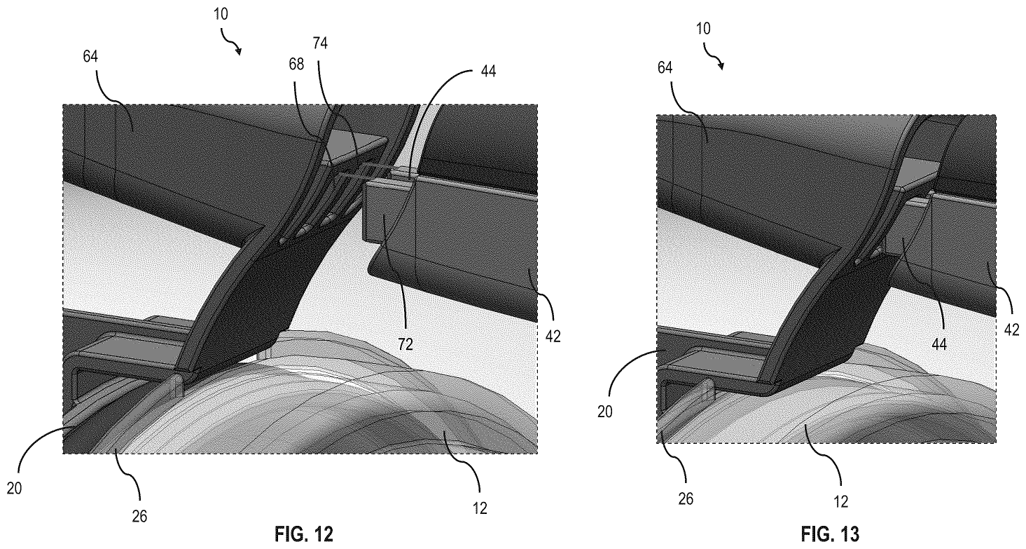

FIGS. 1-15 illustrate a filtering device 10 for a swimming pool or spa according to embodiments. The filtering device 10 generally includes a canister body 12, an inlet 14, an outlet 16, a filter 18, and a canister top 20.

In some embodiments, the filtering device 10 may be an in-line filtering device that is connected to a pump and/or other pool cleaning equipment via hoses or other conduit such that water is drawn into the filtering device 10 via the inlet 14 and exits the filtering device 10 via the outlet 16 (e.g., for continued travel toward a pump). In this regard, the inlet 14 and/or the outlet 16 may be connected to conduit via various attachment mechanisms as desired, such as but not limited to threading, clips, clasps, friction-fit, and/or other mechanisms as desired.

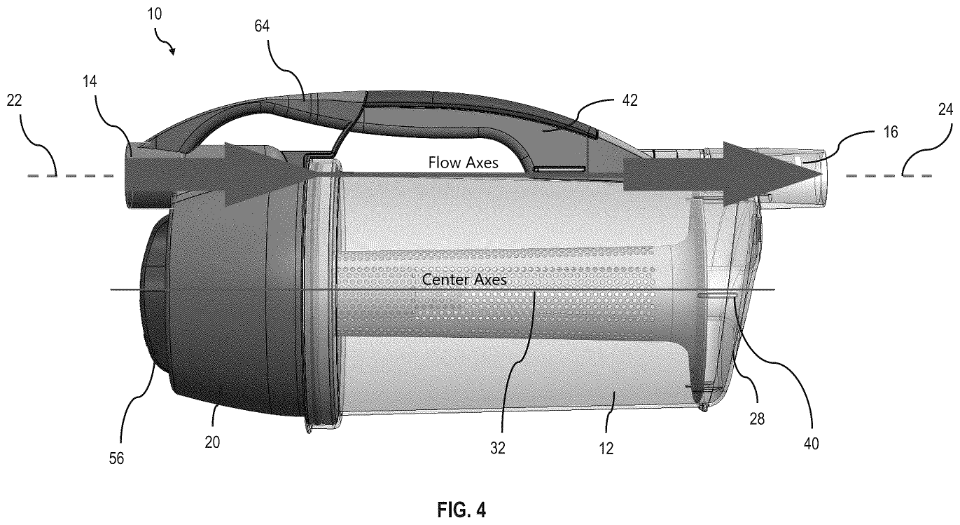

In certain embodiments, the inlet 14 or the outlet 16 is provided on and integrated with the canister top 20, and the other one of the inlet 14 or the outlet 16 is provided on and integrated with the canister body 12. In the embodiment illustrated in FIGS. 1-15, the inlet 14 is on the canister top 20 and the outlet 16 is on the canister body 12. In other embodiments, the inlet 14 may be on the canister body 12 and the outlet 16 may be on the canister top 20. As illustrated in FIG. 4, the inlet 14 has an inlet axis 22 and the outlet 16 has an outlet axis 24 that is parallel to the inlet axis 22. In some embodiments, the inlet axis 22 and the outlet axis 24 are aligned/coaxial, although they need not be in other embodiments.

The canister body 12 is generally elongated and includes a first end 26 and a second end 28. In the embodiment illustrated, the outlet 16 is defined at a location proximate to the second end 28. The first end 26 may include an alignment feature 33, such as but not limited to a notch 34 defined in a flange 36, for facilitating alignment and positioning of the canister top 20 relative to the canister body 12 and as discussed in detail below. While the alignment feature 33 is illustrated as the notch 34 in the flange 36, other suitable alignment features 33 may be utilized as desired.

The canister body 12 defines a chamber 30 in fluid communication with the inlet 14 and the outlet 16 and for at least partially receiving the filter 18. As illustrated in FIG. 4, the canister body 12 includes a center axis 32 that is parallel to and offset from at least the outlet axis 24. In certain embodiments, the center axis 32 is parallel to and offset from both the inlet axis 22 and the outlet axis 24. The center axis 32 parallel to and offset from at least the outlet axis 24 may minimize and/or prevent air from becoming trapped within the canister body 12 (e.g., air may be purged out of the canister body 12). The center axis 32 parallel to and offset from the outlet axis 24 may further promote cyclonic flow within the chamber 30 and filtering of debris using the filter 18 as discussed in detail below.

In certain embodiments, the canister body 12 includes one or more filter positioning features to facilitate positioning and orienting of the filter 18 relative to the canister body 12. In the embodiment illustrated, the positioning features include an internal shaft 38 extending from the second end 28 into the chamber 30 and along the center axis 32. In this embodiment, the internal shaft 38 may be utilized to guide the filter 18 into the chamber 30 by receiving the filter 18 on the internal shaft 38. Additionally, or alternatively, the filter positioning features may include one or more stoppers 40 or other features within the chamber 30 for engaging the filter 18 within the chamber 30. Other features or combinations of features may be utilized for positioning and/or orienting the filter 18 within the chamber 30 as desired.

In various embodiments, a body handle portion 42 is optionally provided on the canister body 12. Optionally, the body handle portion 42 may be buoyant and/or may include a float. Optionally, the body handle portion 42 may include a handle alignment feature 44 to facilitate positioning and engagement of the canister top 20 relative to the canister body 12.

The filter 18 is positionable within the chamber 30 for filtering debris from water as the water flows through the chamber 30. In some embodiments, the filter 18 is positioned within the chamber 30 such that the filter 18 extends along the center axis 32. The filter 18 may have various shapes or profiles as desired. In the embodiment illustrated, the filter 18 has a stem portion 45 and a flange portion 46, which may facilitate filtering of debris by keeping debris from becoming clogged along the length of the filter 18 and pushing debris towards the second end 28, thereby creating more room for debris on the inlet side. In certain embodiments, the flange portion 46 may engage the one or more stoppers 40 and/or otherwise be within the chamber 30 a distance from the second end 28 such that a sub-portion of the chamber 30 may receive filtered water before exiting via the outlet 16.

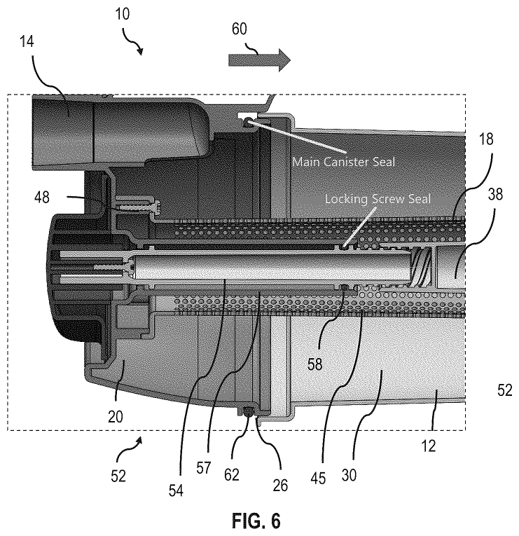

In some embodiments, the filter 18 is attached to the canister top 20 such that the canister top 20 and the filter 18 are movable together. In the illustrated embodiment, and as shown in FIG. 6, a fastener 48 attaches the filter 18 to the canister top 20, although other suitable mechanisms may be used to attach the filter 18 to the canister top 20. Moreover, the filter 18 need not be attached to the canister top 20 in other embodiments.

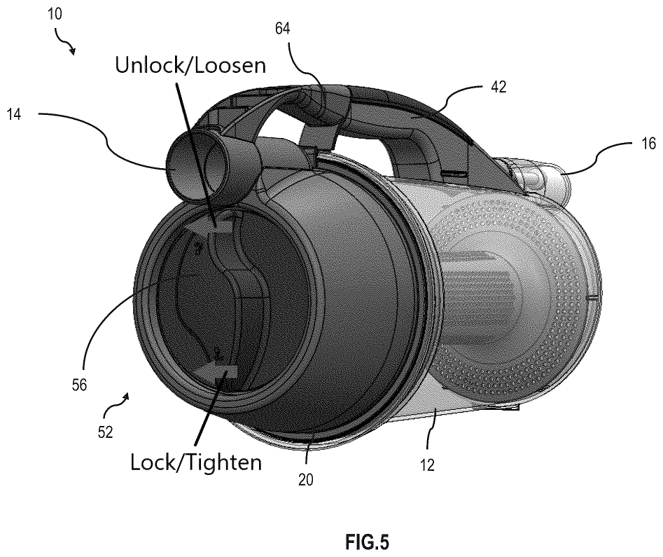

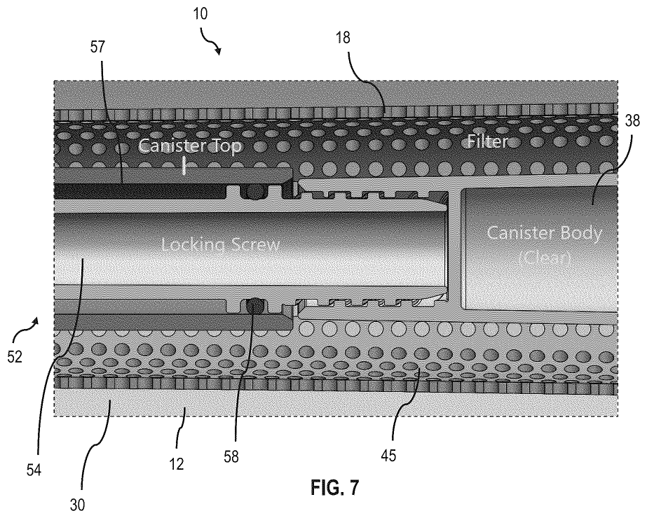

The canister top 20 is attachable to the canister body 12 such that the filter 18 is retained within the chamber 30. In certain embodiments, the canister top 20 attached to the canister body 12 may selectively form a fluid-tight seal with the canister body 12 using a locking assembly 52. As best illustrated in FIGS. 5-7, the locking assembly 52 may include a locking screw 54 and a locking knob 56 coupled to the locking screw 54 such that rotating the locking knob 56 causes rotation of the locking screw 54 (see, e.g., arrows in FIG. 5). As illustrated in FIGS. 6 and 7, in some embodiments, the canister top 20 includes a support stem 57, and the locking screw 54 may be rotatably supported on the canister top 20 and at least partially within the support stem 57. A locking screw sealing member 58 may be provided between the locking screw 54 and the support stem 57 to form a fluid-tight seal between the locking screw 54 and the support stem 57. The locking screw 54 may be rotated into engagement with the internal shaft 38 (e.g., via threading), which may pull the canister top 20 into the first end 26 of the canister body 12 (movement represented by arrow 60) and such that a sealing member 62 forms a fluid-tight seal between the canister top 20 and the canister body 12. Rotation of the locking screw 54 in the opposite direction (e.g., by rotating the locking knob 56 in an opposite direction) may cause disengagement between the canister body 12 and the canister top 20 and/or a loss of the fluid-tight seal between the canister top 20 and the canister body 12.

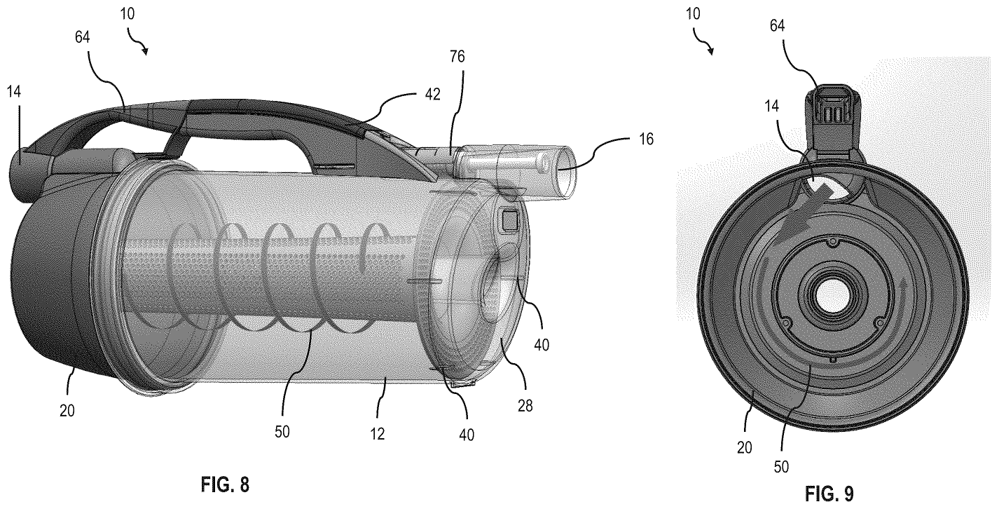

As mentioned, the canister top 20 includes the inlet 14. In certain embodiments, and as best illustrated in FIGS. 6, 8, and 9, the inlet 14 directs water into the canister top 20 and the chamber 30 at an angle and with a rotating or cyclonic flow around the center axis 32. Rotating or cyclonic flow is represented by arrows 50 in FIGS. 8 and 9. The rotating flow generated within the chamber 30 helps keep debris from getting clogged down the center length of the filter 18 and pushes it towards the second end 28, creating more room for debris on the inlet side of the filtering device 10.

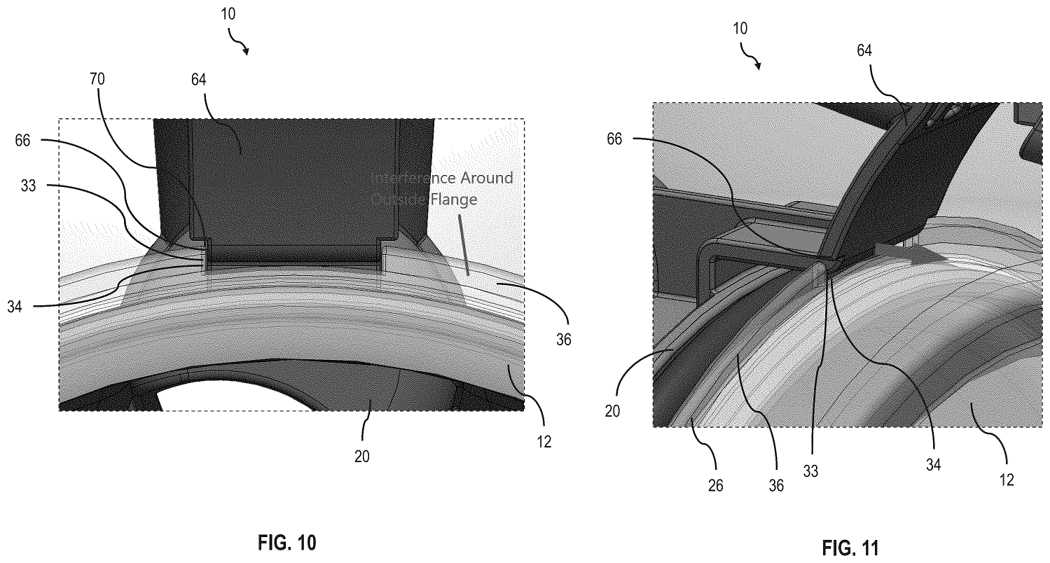

In various embodiments, a top handle portion 64 optionally may be provided on the canister top 20. As best illustrated in FIGS. 10-13, the top handle portion 64 may include one or more alignment features for facilitating alignment and positioning of the canister top 20 relative to the canister body 12. In some embodiments, the top handle portion 64 may include a first alignment feature 66 for engagement with the alignment feature 33 on the canister body 12. As a non-limiting example, the top handle portion 64 may include a cutout portion 70 as the first alignment feature 66 and that is positionable within the notch 34 as the alignment feature 33 on the canister body 12. Such alignment features may provide interference around the perimeter of the canister body 12 unless the alignment features 33, 66 are in a correct alignment or position, after which the canister top 20 may be closed onto the canister body 12 (e.g., via the locking screw 54). In other embodiments, other complementary alignment features may be utilized as desired.

Additionally, or alternatively, the top handle portion 64 includes a second alignment feature 68 for engagement with the handle alignment feature 44 on the body handle portion 42. In such embodiments, the handle alignment feature 44 may be one or more tabs 72 and the second alignment feature 68 may be one or more grooves 74; however, other complementary features may be used in other embodiments. In these embodiments, as the canister top 20 is closed onto the canister body 12 (e.g., due to rotation of the locking screw 54), the one or more tabs 72 may engage the one or more grooves 74 to maintain alignment between the canister top 20 and the canister body 12 while torquing the locking knob 56 closed. Optionally, the second alignment features 68 may at least partially support the top handle portion 64 and the body handle portion 42 when the filtering device 10 is in its closed position.

The canister body 12 is generally elongated and includes a first end 26 and a second end 28. In the embodiment illustrated, the outlet 16 is defined at a location proximate to the second end 28. The first end 26 may include an alignment feature, such as but not limited to a notch 34 defined in a flange 36, for facilitating alignment and positioning of the canister top 20 relative to the canister body 12 and as discussed in detail below. While the alignment feature is illustrated as the notch 34 in the flange 36, other suitable alignment features may be utilized as desired.

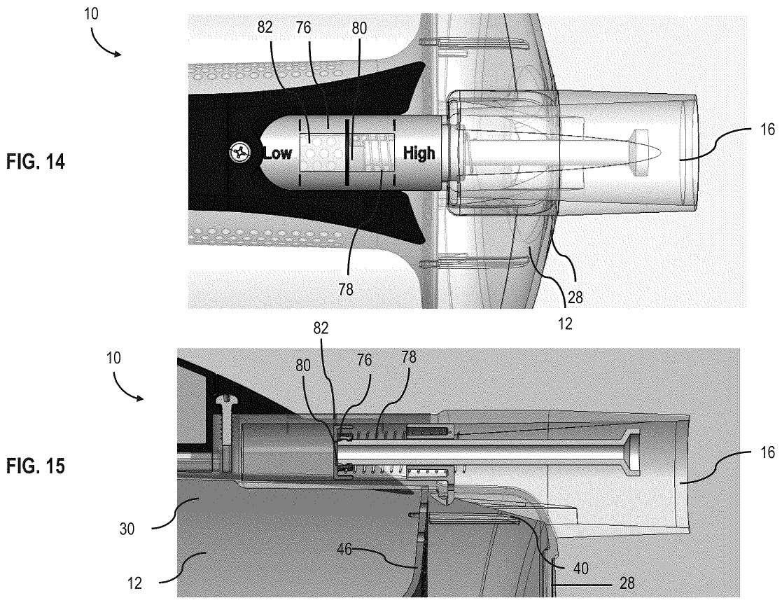

Referring to FIGS. 14 and 15, a flow indicator 76 may be provided with the filtering device 10. In certain embodiments, the flow indicator 76 may be provided within a perimeter of the swimming pool or spa. In some embodiments, the flow indicator 76 is remote and/or downstream from the outlet 16. However, in other embodiments, and as illustrated in FIGS. 14 and 15, the flow indicator 76 may be integrated with the filtering device 10. In such optional embodiments, the integrated flow indicator 76 may allow a user to monitor the flow of fluid through the filtering device 10. The flow indicator 76 may be various types of flow indicators as desired. In the embodiment illustrated, the flow indicator 76 is a spring-based flow gauge with a spring 78 and a plunger 80. In these embodiments, the spring 78 applies a biasing force against the plunger 80, and a change in force on the plunger 80 due to a change in differential pressure causes movement of the plunger 80, which may be viewed using a visual indicator 82. In other embodiments, other types of flow indicators 76 may be utilized as desired.

Exemplary concepts or combinations of features of the invention may include:
A. An in-line filtering device for a swimming pool or spa, the in-line filtering device comprising an inlet, an outlet, and a filter between the inlet and the outlet, wherein the inlet and the outlet are parallel to and offset from a center axis of the filter.
B. The in-line filtering device of any preceding or subsequent statement or combination of statements, wherein the in-line filtering device is configured to generate horizontal cyclonic flow of water.
C. An in-line filtering device comprising a canister top defining an inlet, a canister body defining an outlet and comprising a center axis, wherein the inlet and the outlet are parallel to but offset from the center axis.
D. An in-line filtering device comprising an inlet, and outlet, and a canister body, wherein the in-line filtering device is configured to generate cyclonic flow within the canister body about an axis parallel to and offset from the inlet and the outlet.
E. The in-line filtering device of any preceding or subsequent statement or combination of statements, further comprising a handle on the canister body, and wherein the handle is buoyant.
F. The in-line filtering device of any preceding or subsequent statement or combination of statements, further comprising a flow indicator.
G. The in-line filtering device of any preceding or subsequent statement or combination of statements, wherein the flow indicator is integral with the canister body.
H. The in-line filtering device of any preceding or subsequent statement or combination of statements, wherein the flow indicator is within a perimeter of the swimming pool or spa.
I. The in-line filtering device of any preceding or subsequent statement or combination of statements, wherein the flow indicator is offset from the center axis of the canister body.
J. An in-line filtering device comprising a canister top defining an inlet, a canister body defining an outlet, and a filter within the canister body, and wherein the canister top further comprises a locking knob for selectively sealing the canister top relative to the canister body.
K. The in-line filtering device of any preceding or subsequent statement or combination of statements, further comprising a locking screw coupled to the locking knob, the locking screw configured to engage an internal shaft of the canister body.
L. The in-line filtering device of any preceding or subsequent statement or combination of statements, wherein the canister top comprises a first sealing member for forming a seal between the canister body and the canister top, and wherein the locking screw comprises a second sealing member for forming a seal between the locking screw and the canister top.
M. The in-line filtering device of any preceding or subsequent statement or combination of statements, wherein the canister top comprises a first handle portion and the canister body comprises a second handle portion, and wherein the first handle portion and the second handle portion have alignment features for orienting the canister top relative to the canister body before sealing the canister body.
N. An in-line filter device of any preceding or subsequent statement or combination of statements, wherein a maximum dimension of the in-line filter device is in a direction parallel to an axis of the inlet and/or an axis of the outlet, and wherein an axis of the in-line filter device is parallel to and offset from the axis of the inlet and/or the axis of the outlet.
O. An in-line filtering device comprising a canister top defining an inlet, a canister body defining an outlet, and a filter within the canister body, wherein an axis of the filter is parallel to and offset from at least one of an axis of the inlet or an axis of the outlet.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with pools and spas, persons skilled in the relevant field will recognize that the present invention conceivably could be employed in connection with other objects and in other manners. Finally, references to “pools” and “swimming pools” herein may also refer to spas or other water containing vessels used for recreation or therapy and for which cleaning of debris is needed or desired.

As used herein, the meaning of “a,” “an,” and “the” includes singular and plural references unless the context clearly dictates otherwise.

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “vertical,” “horizontal,” “lateral,” “longitudinal,” “front,” and “back,” among others, are intended to refer to the orientation as illustrated and described in the figure (or figures) to which the components and directions are referencing.

The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention, and does not pose a limitation on the scope of the invention unless otherwise claimed. No language in the specification should be construed as indicating any non-claimed element as essential to the practice of the invention.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. An in-line filtering device for a swimming pool or spa, the in-line filtering device comprising an inlet, an outlet, and a filter between the inlet and the outlet, wherein the inlet and the outlet are parallel to and offset from a center axis of the filter.

2. The in-line filtering device of claim 1, wherein the in-line filtering device is configured to generate horizontal cyclonic flow of water.

3. The in-line filtering device of claim 1, wherein the in-line filtering device further comprises:
a canister top; and
a canister body,
wherein the canister top defines the inlet, and
wherein the canister body defines the outlet.

4. The in-line filtering device of claim 3, wherein the canister body comprises a center axis, and wherein the inlet and the outlet are parallel to but offset from the center axis.

5. The in-line filtering device of claim 1, further comprising a canister top, a canister body, and a handle on the canister body, and wherein the handle is buoyant.

6. The in-line filtering device of claim 1, further comprising a flow indicator.

7. The in-line filtering device of claim 6, wherein the flow indicator is at least one of integral with a canister body of the filter or offset from a center axis of the canister body.

8. An in-line filtering device for a swimming pool or spa, the in-line filtering device comprising an inlet, and outlet, and a canister body, wherein the in-line filtering device is configured to generate cyclonic flow within the canister body about an axis parallel to and offset from the inlet and the outlet.

9. The in-line filtering device of claim 8, further comprising a filter within the canister body.

10. The in-line filtering device of claim 8, further comprising a canister top defining the inlet, wherein the canister body defines the outlet, and wherein the canister top further comprises a locking knob for selectively sealing the canister top relative to the canister body.

11. The in-line filtering device of claim 10, further comprising a locking screw coupled to the locking knob, the locking screw configured to engage an internal shaft of the canister body.

12. The in-line filtering device of claim 11, wherein the canister top comprises a first sealing member for forming a seal between the canister body and the canister top, and wherein the locking screw comprises a second sealing member for forming a seal between the locking screw and the canister top.

13. The in-line filtering device of claim 10, wherein the canister top comprises a first handle portion and the canister body comprises a second handle portion, and wherein the first handle portion and the second handle portion have alignment features for orienting the canister top relative to the canister body before sealing the canister body.

14. The in-line filtering device of claim 8, wherein the in-line filtering device is configured to generate horizontal cyclonic flow of water.

15. The in-line filter device of claim 8, wherein a maximum dimension of the in-line filter device is in a direction parallel to an axis of the inlet and/or an axis of the outlet, and wherein an axis of the in-line filter device is parallel to and offset from the axis of the inlet and/or the axis of the outlet.

16. An in-line filtering device for a swimming pool or spa, the in-line filtering device comprising a canister top defining an inlet, a canister body defining an outlet, and a filter within the canister body, wherein an axis of the filter is parallel to and offset from at least one of an axis of the inlet or an axis of the outlet.

17. The in-line filtering device of claim 16, wherein the in-line filtering device is configured to generate horizontal cyclonic flow of water.

18. The in-line filter device of claim 16, wherein a maximum dimension of the in-line filter device is in a direction parallel to an axis of the inlet and/or an axis of the outlet, and wherein an axis of the in-line filter device is parallel to and offset from the axis of the inlet and/or the axis of the outlet.

19. The in-line filtering device of claim 16, further comprising a flow indicator.

20. The in-line filter device of claim 16, wherein the canister top further comprises a locking knob for selectively sealing the canister top relative to the canister body.
